(19) United States
(12) Patent Application Publication
(10) Pub. No.: US 2024/0063693 A1
(43) Pub. Date: Feb. 22, 2024

(54) MOTOR

(71) Applicant: LG INNOTEK CO., LTD., Seoul (KR)

(72) Inventor: Jung Kyu LEE, Seoul (KR)

(21) Appl. No.: 18/271,509

(22) PCT Filed: Jan. 11, 2022
(86) PCT No.: PCT/KR2022/000411

§ 371 Date: Jul. 10, 2023

(30) Foreign Application Priority Data
Jan. 11, 2021 (KR) 10-2021-0003259

(51) Int. Cl. H02K 11/215; H02K 1/28

(52) U.S. Cl. CPC H02K 11/215; H02K 1/28

(57) ABSTRACT

The present invention provides a motor including a shaft, a rotor coupled to the shaft, a stator positioned to correspond to the rotor, a holder disposed at one side of the shaft, and a sensing magnet disposed on the holder, wherein the shaft includes a body and a screw extending from the body in a radial direction, and the screw is disposed in the holder.

### TECHNICAL FIELD

The present invention relates to a motor.

### BACKGROUND ART

A motor includes a rotor and a stator. The rotor rotates due to an electrical interaction between the rotor and the stator. In addition, a shaft coupled to the rotor rotates. A detection unit including a magnetic element is disposed inside the motor. The magnetic element detects a magnetic force of a sensing magnet which rotates with the shaft to check a current position of the rotor.

However, since a fixing force between the sensing magnet and the shaft is low, there is a possibility that the sensing magnet is separated from the shaft. Accordingly, there is a problem of reducing the sensing sensitivity of the magnetic element.

### DISCLOSURE

### Technical Problem

Accordingly, the present invention is directed to providing a motor in which a fixing force between a shaft and a holder is increased.

### Technical Solution

One aspect of the present invention provides a motor including a shaft, a rotor coupled to the shaft, a stator positioned to correspond to the rotor, a holder disposed at one side of the shaft, and a sensing magnet disposed on the holder, wherein the shaft includes a body and a screw extending from the body in a radial direction, and the holder includes a groove in which the screw is disposed.

### Advantageous Effects

According to an embodiment, a shaft and a holder can be fastened using a screw to increase a fixing force between the shaft and the holder, and a sensing magnet can be stably fixed to improve the detection performance of a magnetic element.

According to an embodiment, the management of a press-fit tolerance between a holder and a shaft is easy, and the shaft can be coupled to the holder without a press-fit process in some cases, and thus a motor which is easy to manufacture and is reliable is provided.

### DESCRIPTION OF DRAWINGS

FIG. 1 is a cross-sectional view illustrating a motor according to one embodiment of the present invention.

FIG. 2 is a perspective view illustrating a shaft.

FIG. 3 is a perspective view illustrating a holder.

FIG. 4 is a perspective view illustrating the shaft, the holder, and a sensing magnet.

FIG. 5 is an exploded perspective view illustrating the shaft, the holder, and the sensing magnet.

FIG. 6 is a cross-sectional view illustrating the shaft, the holder, and the sensing magnet.

FIG. 7 is a cross-sectional view illustrating a shaft, a holder, and a sensing magnet of a motor according to another embodiment of the present invention.

### MODES OF THE INVENTION

Hereinafter, exemplary embodiments of the present invention will be described in detail with reference to the accompanying drawings.

A direction parallel to a longitudinal direction (vertical direction) of a shaft is referred to as an axial direction, a direction perpendicular to the axial direction of the shaft is referred to as a radial direction, and a direction along a circle having a radius in the radial direction from the shaft is referred to as a circumferential direction.

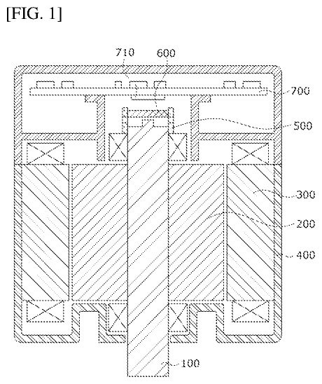

FIG. 1 is a cross-sectional view illustrating a motor according to one embodiment of the present invention.

Referring to FIG. 1, a motor includes a shaft 100, a rotor 200, a stator 300, a housing 400, a holder 500, a sensing magnet 600, and a circuit board 700.

Hereinafter, the term “inward” is a direction from the housing 400 toward the shaft 100 which is a center of the motor, and the term “outward” is a direction opposite to “inward,” that is, a direction from the shaft 100 toward the housing 400.

The shaft 100 may be coupled to the rotor 200. When a current is supplied and an electromagnetic interaction occurs between the rotor 200 and the stator 300, the rotor 200 rotates, and the shaft 100 rotates in conjunction with the rotor 200. The shaft 100 may be coupled to a steering system of a vehicle to transmit power to the steering system.

The rotor 200 rotates due to an electrical interaction between the rotor 200 and the stator 300. The rotor 200 may be disposed inside the stator 300. The rotor 200 may include a rotor core and a rotor magnet disposed on the rotor core.

The stator 300 is disposed outside the rotor 200. The stator 300 may include a stator core, a coil, and an insulator mounted on the stator core 310. The coil may be wound around the insulator 330. The insulator is disposed between the coil and the stator core. The coil induces an electrical interaction with the rotor magnet.

The housing 400 may be disposed outside the stator 300. The housing 400 may be a cylindrical member of which one side is open. A shape or a material of the housing 400 may be variously changed, and a metal material which can withstand high temperatures may be selected.

The holder 500 is coupled to the shaft. The holder 500 rotates in conjunction with the rotor 200 and the shaft 100. The holder 500 may be a non-magnet.

The sensing magnet 600 is coupled to the shaft 100 to operate in conjunction with the rotor 200. The sensing magnet 600 is a device for detecting a position of the rotor 200.

The circuit board 700 may be disposed to be spaced apart from the shaft 100. The circuit board 700 may be a printed circuit board (PCB). In addition, a sensor 710 may be mounted on the circuit board 700. The sensor 710 may be disposed to face the sensing magnet 600. The sensor 710 may be spaced apart from the sensing magnet 600. The sensor 710 may be a Hall integrated circuit (IC). The sensor 710 may detect changes in N and S poles of the sensing magnet 600 to generate a sensing signal.

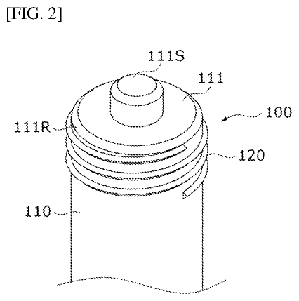

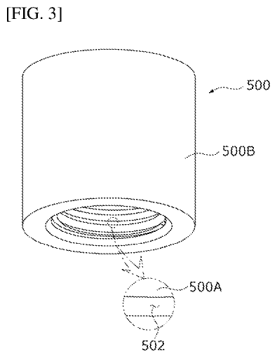

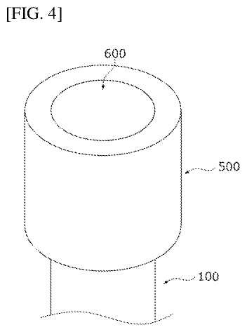

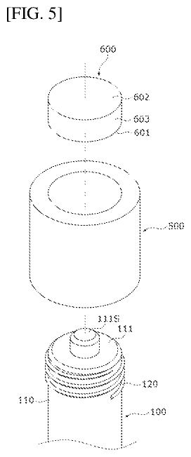

FIG. 2 is a perspective view illustrating the shaft, and FIG. 3 is a perspective view illustrating the holder. FIG. 4 is a perspective view illustrating the shaft, the holder, and the sensing magnet, and FIG. 5 is an exploded perspective view illustrating the shaft, the holder, and the sensing magnet.

Referring to FIGS. 2 to 5, the shaft 100 may include a body 110 and a screw 120. The body 110 may include a first end portion 111 and a second end portion (not shown). The first end portion 111 may be press-fitted into the holder 500. A rounded portion 111R may be disposed at an edge of the first end portion 111. In addition, the body 110 may include a protrusion 111S disposed on the first end portion 111. A diameter of the protrusion 111S may be smaller than a diameter of the body 110.

The shaft 100 includes the screw 120. The screw 120 may be disposed closer to the first end portion 111 than the second end portion (not shown). The screw 120 may be disposed at a predetermined distance from the first end portion 111. The screw 120 may protrude from an outer circumferential surface of the shaft 100 in a radial direction. In addition, the screw 120 may extend in a helical shape. However, the present invention is not limited thereto, and the screw 120 may be designed in a variety of shapes protruding from the body 110 in the radial direction. The screw 120 may be inserted into the holder 500. In this case, the shaft 100 may rotate to be inserted into the holder 500. In addition, in a process in which the shaft 100 is inserted into the holder 500, the screw 120 may rotate and form a helical groove 502 in the holder 500.

The shaft 100 may be formed of a steel material. The body 110 and the screw 120 may be integrally formed. In this case, thermal processing may be performed on the screw 120 before the screw 120 is press-fitted into the holder 500. The thermal processed screw 120 may have a hardness greater than a hardness of the body 110.

The holder 500 may have a cylindrical shape. The holder 500 may have an inner space. The sensing magnet 600 may be disposed at one side in the space. The sensing magnet 600 may be press-fitted into the holder 500. In addition, the first end portion 111 of the shaft 100 may be disposed at the other side in the space. The shaft 100 may be press-fitted into the holder 500. In this case, the first end portion 111 may be disposed at an axial distance from the sensing magnet 600. Accordingly, a gap G may be formed between the first end portion 111 and the sensing magnet 600. An adhesive may be disposed in the gap G.

The holder 500 may include a hole 501. The hole 501 may be provided as a plurality of holes 501. The holes 501 may be disposed in a circumferential direction. The plurality of holes 501 may be disposed at equal intervals. The adhesive may fill the gap G through the holes 501. The holes 501 may pass through the holder 500 from an inner circumferential surface 500A to an outer circumferential surface 500B. In addition, a diameter of the hole 501 formed in the inner circumferential surface 500A may be smaller than a diameter of the hole 501 formed in the outer circumferential surface 500B.

The holder 500 may include the groove 502 formed in the inner circumferential surface 500A. The groove 502 may be formed in the helical shape. The screw 120 may be disposed in a part of the groove 502. The holder 500 may be formed of a steel material. The holder 500 may have a hardness lower than the hardness of the screw 120.

The shaft 100 may be press-fitted into the holder. The first end portion 111 may be disposed in the holder 500. The sensing magnet 600 may be fixed in the holder 500. The sensing magnet 600 may be in contact with a part of the inner circumferential surface 500A of the holder 500. In addition, the shaft 100 may be in contact with another part of the inner circumferential surface 500A of the holder 500.

The shaft 100 may rotate to be press-fitted into the holder 500. Accordingly, the screw 120 may rotate and rub against the inner circumferential surface 500A. In this case, the screw 120 may have the hardness greater than a hardness of the inner circumferential surface 500A. According to the embodiment, the groove 502 may be formed so that the inner circumferential surface 500A is worn by the screw 120 in a process in which the shaft 100 is press-fitted into the holder 500. The groove 502 may be formed in a region through which the screw 120 passes. In addition, after the shaft 100 is press-fitted into the holder 500, an adhesive may be injected through the hole 501 to increase a fixing force between the shaft 100 and the holder 500.

The groove 502 may include a first region 502A and a second region 502B. The screw 120 may be disposed in the first region 502A. In addition, the second region 502B may be a region other than the first region 502A. The screw 120 may not be disposed in the second region 502B. The second region 502B may be formed while the screw 120 passes.

An inner diameter of the holder 500 may be smaller than or equal to an outer diameter of the shaft 100. In this case, the shaft 100 may be press-fitted into the holder 500. The holder 500 may include the inner circumferential surface 500A and the outer circumferential surface 500B. The inner circumferential surface 500A of the holder may be in contact with the outer circumferential surface of the shaft 100. Meanwhile, the inner diameter of the holder 500 may also be greater than the outer diameter of the shaft 100. In this case, the shaft 100 may slide into the holder 500. A first gap (not shown) may be formed between the inner circumferential surface 500A of the holder 500 and the outer circumferential surface of the shaft 100. Conventionally, the management of a press-fit tolerance between the holder and the shaft is difficult, but in the motor according to the present invention, managing a tolerance between the inner circumferential surface of the holder and the outer circumferential surface of the shaft is easy.

The sensing magnet 600 may be press-fitted into the holder 500. The sensing magnet 600 includes a first surface 601, a second surface 602, and a third surface 603. The first surface 601 and the second surface 602 are disposed in an axial direction. The first surface 601 is disposed to face the shaft 100. The first surface 601 may be spaced apart from an end portion of the shaft 100. In addition, the second surface 602 is disposed to face an opposite side of the first surface 601. The second surface 602 may face the sensor 710 (illustrated in FIG. 1). The first surface 601 and the second surface 602 are connected by the third surface 603. The third surface 603 may be provided as one or more third surfaces 603. The third surface 603 may be a curved surface but is not limited thereto. The holder 500 may surround the third surface 603.

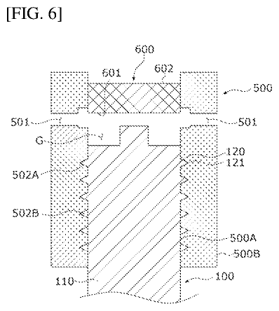

FIG. 6 is a cross-sectional view illustrating the shaft, the holder, and the sensing magnet.

Referring to FIG. 6, the screw 120 may be disposed in a part of the groove 502. In addition, an outer circumferential surface of the body 110 may be in contact with the inner circumferential surface 500A. Meanwhile, the first gap may be formed between the outer circumferential surface 500A of the body 110 and the inner circumferential surface 500A. In this case, the shaft 100 may be press-fitted into or slid in the holder 500.

The screw 120 may be in contact with the holder 500. In addition, the screw 120 may be fastened to the groove 502. The screw 120 may be fixed in the groove 502 without movement in axial and radial directions. The radial length of the screw 120 may be greater than a distance between the body 110 and the inner circumferential surface 500A of the holder 500.

The screw 120 may extend in a helical direction. The screw 120 may include a blade 121 disposed to face outward. The blade 121 may have a shape of which a thickness decreases toward the holder 500. In this case, the inner circumferential surface 500A of the holder 500 may be worn by the blade 121 to form the groove 502. A hardness of the blade 121 may be greater than the hardness of the inner circumferential surface 500A of the holder 500. The shape of the screw 120 may be designed in a variety of shapes other than the helical shape.

The adhesive may be injected through the hole 501. The injected adhesive may be disposed in the gap G in the holder 500. The adhesive may couple the sensing magnet 600 and the first end portion 111. The adhesive may be disposed in the hole 501. The hole 501 may be closed by the adhesive. A width of the hole 501 may increase from the outer circumferential surface 500B toward the inner circumferential surface 500A.

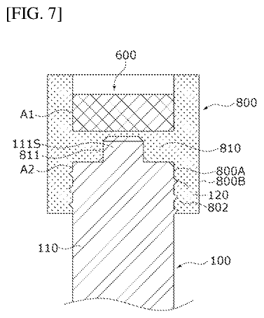

FIG. 7 is a cross-sectional view illustrating a shaft, a holder, and a sensing magnet of a motor according to another embodiment of the present invention. The present embodiment is the same as the motor illustrated in FIG. 5 except for the shape of the holder. Accordingly, same reference numerals will be assigned to components which are the same as the components in FIG. 6, and repetitive descriptions thereof will be omitted.

Referring to FIG. 7, a holder 800 may include a first member 810. The first member 810 may be disposed between a sensing magnet 600 and a first end portion 111. The first member 810 may include a first groove 811. A protrusion 111S may be disposed in the first groove 811. The first member 810 may divide an inner space of the holder 800. The sensing magnet 600 may be press-fitted into one side of the divided space, and a shaft 100 may be press-fitted into the other side.

The holder 800 may include an inner circumferential surface 800A and an outer circumferential surface 800B. The inner circumferential surface 800A may include a first region A1 and a second region A2. The first member 810 may be disposed between the first region A1 and the second region A2. The first region A1 may be in contact with the press-fitted sensing magnet 600. In addition, the press-fitted shaft 100 may be disposed in the second region A2. A second groove 802 in which a screw 120 is disposed may be formed in the second region A2. In this case, a part of the screw 120 may not overlap the holder 800. According to the embodiment, the shaft and the holder may be connected using the screw to increase a fixing force between the shaft and the holder, and the sensing magnet may be stably fixed to improve the detection performance of a magnetic element.

In the above embodiments, an example of an inner rotor type motor has been described, but the present invention is not limited thereto. The present invention can also be applied to an outer rotor type motor. In addition, the present invention can be used in various devices such as vehicles or home appliances.

1. A motor comprising:
a shaft;
a rotor coupled to the shaft;
a stator positioned to correspond to the rotor;
a holder disposed at one side of the shaft; and
a sensing magnet disposed on the holder,
wherein the shaft includes a body and a screw extending from the body in a radial direction, and
the holder includes a groove in which the screw is disposed,
wherein the shaft includes a first end portion, a protrusion disposed on the first end portion,
wherein the holder includes a first member disposed between the sensing magnet and the first end portion,
wherein the first member includes a first groove, and the protrusion is disposed in the first groove.

2. The motor of claim 1, wherein:
a hardness of the screw is greater than a hardness of the body; and
the hardness of the screw is greater than a hardness of the holder.

3. The motor of claim 1, wherein:
a gap is formed between the sensing magnet and the shaft; and
at least one hole that communicates with the gap is formed in the holder.

4. The motor of claim 3, wherein:
the hole passes through the holder from an outer circumferential surface to an inner circumferential surface thereof; and
a diameter of the hole formed in the outer circumferential surface of the holder is smaller than a diameter of the hole formed in the inner circumferential surface of the holder.

5. The motor of claim 1, wherein:
the protrusion is spaced apart from the sensing magnet in the axial direction.

6. The motor of claim 5, wherein the shaft includes a rounded portion disposed on an edge of the first end portion.

7. The motor of claim 4, wherein:
the groove includes a first region in which the screw is disposed and a second region except the first region; and
the second region faces the outer circumferential surface of the body.

8. The motor of claim 1, wherein an inner diameter of the holder is smaller than or equal to an outer diameter of the body of the motor.

9. The motor of claim 1, wherein an inner diameter of the holder is greater than an outer diameter of the body of the motor.

10. The motor of claim 9, wherein a first gap is formed between an inner circumferential surface of the holder and an outer circumferential surface of the shaft.
